(19) United States
(12) Patent Application Publication
(10) Pub. No.: US 2016/0252858 A1
(43) Pub. Date: Sep. 1, 2016

(54) IMAGE FORMATION APPARATUS, METHOD OF CONTROLLING IMAGE FORMATION APPARATUS, AND FIXING UNIT

(71) Applicant: Oki Data Corporation, Tokyo (JP)

(72) Inventor: Masayuki SAKAI, Tokyo (JP)

(73) Assignee: Oki Data Corporation, Tokyo (JP)

(21) Appl. No.: 14/994,205

(22) Filed: Jan. 13, 2016

(30) Foreign Application Priority Data
Feb. 27, 2015 (JP) 2015-039189

(51) Int. Cl. G03G 15/20

(52) U.S. Cl. CPC G03G 15/2085; G06K 15/129; G06K 15/16

(57) ABSTRACT

An image formation apparatus includes: an image formation device to form a developer image based on image data; a transfer device to transfer the developer image onto a recording medium; a fixing unit including a rotary body and configured to fix the developer image by rotating the rotary body in a first direction to move the recording medium to a downstream side in the conveyance path to heat and press the recording medium, and a wrap-around detection device to detect when the recording medium with the developer image is wrapped around the rotary body. The wrap-around detection device detects that the recording medium is wrapped around the rotary body based on a detected temperature of the rotary body and based on a medium detection result of detecting the recording medium on the upstream and downstream sides of the rotary body in the medium conveyance path.

### CROSS REFERENCE TO RELATED APPLICATIONS

This application claims priority based on 35 USC 119 from prior Japanese Patent Application No. 2015-039189 filed on Feb. 27, 2015, entitled “IMAGE FORMATION APPARATUS, METHOD OF CONTROLLING IMAGE FORMATION APPARATUS, AND FIXING UNIT”, the entire contents of which are incorporated herein by reference.

### BACKGROUND OF THE INVENTION

1. Field of the Invention

The invention relates to an image formation apparatus, a method of controlling the image formation apparatus, and a fixing unit.

2. Description of Related Art

A conventional electrophotographic image formation apparatus is provided with a fixing unit in which a fixing roller as a heating roller and a pressure roller forms a nip portion. After a developer image is formed on a recording medium such as a sheet of paper, the fixing unit fixes the developer image to the recording medium by heating and pressing the recording medium while conveying the recording medium between the fixing roller and the pressure roller.

A general one of the conventional techniques to prevent a recording medium from being wrapped around the fixing roller when passing through the fixing unit is a separator. However, the separator cannot completely prevent a recording medium from being wrapped around the fixing roller because there needs to be a gap between the separator and the fixing roller which is a rotary body.

For this reason, when a wrap-around jam (jam: a recording medium is stuck and cannot move) occurs due to the wrapping of a recording medium around the fixing roller or any other reason, it is desirable to detect the wrap-around jam and conduct a recovery process to prevent the wrap-around jam from further proceeding. In the conventional technique disclosed in Japanese Patent Application Publication No. 2000-344395, an image formation apparatus is provided with an ejection sensor to detect the state of a recording medium passing a predetermined position. The ejection sensor monitors and provides detections of leading and trailing edges of the recording medium for a predetermined length of time. This enables the detection of a recording medium wrapped around. When such a wrap-around jam occurs, the image formation apparatus is stopped from driving, and notifies the user of the occurrence of the wrap-around jam.

### SUMMARY OF THE INVENTION

However, in the conventional image formation apparatus, the method of controlling the image formation apparatus and the fixing unit results in some of the recording media remaining looped (wrapped) within the fixing unit and not being detected, depending on the type, color, and thickness thereof.

Recording media, of recent years especially, are of a wide variety, including many recording media that are made of urethane resin and polyethylene terephthalate (PET) materials, which melt due to heat of the fixing unit and adhere to the surface of the fixing roller. Accordingly, wrap-around jams are more likely to occur, and it is difficult to solve the aforementioned problem.

An aspect of the invention is an image formation apparatus that includes: an image formation device configured to form a developer image based on image data; a transfer device configured to transfer the developer image formed by the image formation device onto a recording medium; a fixing unit including a rotary body and configured to fix the developer image, when the recording medium with the developer image transferred thereon is conveyed from an upstream side in a conveyance path, by rotating the rotary body in a first direction to move the recording medium to a downstream side in the conveyance path while heating and pressing the recording medium; and a wrap-around detection device configured to detect if the recording medium with the developer image transferred thereto is wrapped around the rotary body. The wrap-around detection device detects if the recording medium is wrapped around the rotary body based on the result of detecting the temperature of the rotary body and the medium detection results of detecting the recording medium on the upstream and downstream sides of the rotary body.

According to the aspect of the invention, it is possible to precisely detect a wrapped recording medium remaining within the fixing unit.

### BRIEF DESCRIPTION OF THE DRAWINGS

FIG. 1 is an enlarged diagram illustrating a belt-type fixing unit illustrated in FIG. 2.

FIG. 2 is a schematic cross-sectional diagram illustrating an image formation apparatus of Embodiment 1 of the invention.

FIG. 3 is a diagram for explaining the configuration of a discharge separator of the fixing unit of FIG. 1.

FIG. 4 is a block diagram illustrating a schematic circuit configuration of the fixing unit and peripheries thereof in the image formation apparatus of FIG. 2.

FIG. 5 is a flowchart illustrating a control method in case of a jam error in the image formation apparatus of FIG. 4.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

### Embodiment 1

### Configuration of Embodiment 1

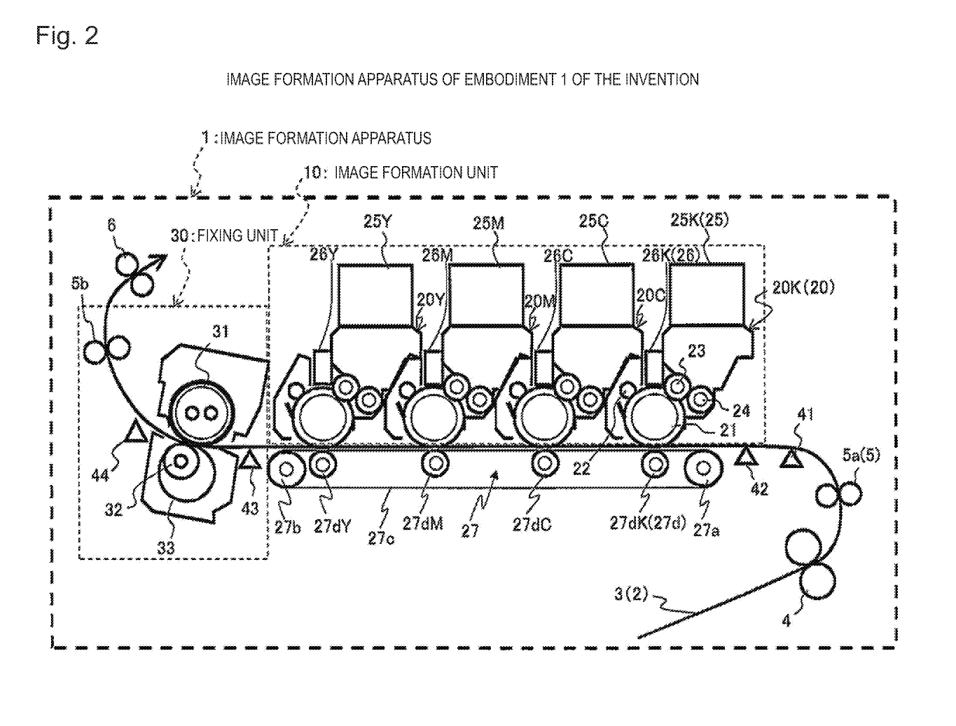

FIG. 2 is a schematic cross-sectional diagram illustrating an image formation apparatus of Embodiment 1 of the invention.

Image formation apparatus 1 is an electrophotographic color printer, for example. Image formation apparatus 1 converts information received from an external device or a host device, such as a personal computer (hereinafter, referred to as a PC) into image data, and forms (prints) an image on recording medium 2, such as paper, based on the image data.

Image formation apparatus 1 includes conveyance path 3 for a recording medium 2, such as paper. On conveyance path 3, a paper feed roller pair 4, conveyance roller pairs 5 (=5a, 5b, . . . ), and delivery roller pair 6 are provided to convey recording medium 2 in an intended direction. On the downstream side of paper feed roller pair 4, image formation section 10 as an image formation device is provided. Under image formation section 10, transfer unit 27 is provided as a transfer device. On the downstream side of image formation section 10 and transfer unit 27, fixing unit 30 is provided.

Image formation section 10 is configured to form a developer (hereinafter, referred to as toner) image based on inputted image data. Transfer unit 27 transfers the toner image formed by image formation section 10 onto recording medium 2. Fixing unit 30 is a belt-type fixing unit, for example, and is configured to heat and press recording medium 2 with the toner image transferred thereon to fix the toner image.

Along conveyance path 3 between paper feed roller pair 4, and image formation section 10 (transfer unit 27), IN sensor 41 and WR sensor 42 are provided. IN sensor 41 is a sensor to detect recording medium 2 fed along conveyance path 3. WR sensor 42 is a write sensor to detect fed recording medium 2 just before image formation section 10 and transfer unit 27, and to determine the write timing of image formation section 10.

Between the downstream side of image formation section 10 (transfer unit 27) and the upstream side of fixing unit 30, slack sensor 43 is provided as a first medium sensor. In addition, also on the downstream side of fixing unit 30, ejection sensor 44 is provided as a second medium sensor. Slack sensor 43 detects whether recording medium 2, fed with an image transferred thereon, has a slack or not between the downstream side of image formation section 10 (transfer unit 27) and the upstream side of fixing unit 30. Ejection sensor 44 detects whether recording medium 2 is discharged out of fixing unit 30 toward delivery roller pair 6.

Image formation section 10 is provided with image formation units (hereinafter, referred to as ID units) 20 for multiple colors (four colors, for example). ID units 20 for four colors are ID unit 20K for black, ID unit 20C for cyan, ID unit 20M. for magenta, and ID unit 20Y for yellow, for example. ID unit 20 for each color includes photoreceptive drum 21 as an image carrier, on the surface of which an electrostatic latent image is formed. The outer circumferential surface of photoreceptive drum 21 is in contact with charging roller 22 as a charging device and development roller 23 as a development device. Charging roller 22 uniformly charges photoreceptive drum 21. Development roller 23 develops an electrostatic latent image formed on photoreceptive drum 21 to form a toner image.

The outer circumferential surface of development roller 23 is in contact with supply roller 24 as a toner supply device. Supply roller 24 supplies to development roller 23, color toner supplied from a corresponding toner cartridge 25 that stores toner. Moreover, supply roller 24 triboelectrically charges the toner. Toner cartridges 25 include black toner cartridge 25K, cyan toner cartridge 25C, magenta toner cartridge 25M, and yellow toner cartridge 25Y, for example. Toner cartridge 25 for each color is detachably attached to a corresponding ID unit 20. A light emitting device (hereinafter referred to as an LED) head 26 as an exposure device is provided in the vicinity of photoreceptive drum 21 for each color. LED heads 26 include black LED head 26K, cyan LED head 26C, magenta LED head 26M, and yellow LED head 26Y, for example. LED head 26 for each color projects light onto the surface of a corresponding charged photoreceptive drum 21 to form an electrostatic latent image.

Under photoreceptive drums 21, transfer unit 27 is provided. Transfer unit 27 includes driving roller 27a and driven roller 27b at a predetermined distance from each other, and endless transfer belt 27c and transfer rollers 27d for each color. Transfer belt 27c is suspended between driving and driven rollers 27a and 27b. Transfer rollers 27d are arranged within transfer belt 27c. Transfer rollers 27d include black transfer roller 27dK, cyan transfer roller 27dC, magenta transfer roller 27dM, and yellow transfer roller 27dY, for example. Transfer belt 27c conveys recording medium 2 fed along conveyance path 3 to under image formation section 10. Transfer roller 27d for each color is in contact with a corresponding photoreceptive drum 21, with transfer belt 27c interposed therebetween to transfer the toner image formed on photoreceptive drum 21 onto recording medium 2 on transfer belt 27c.

When recording medium 2 passes through paper feed roller pair 4 on conveyance path 3, recording medium 2 is detected by IN sensor 41 before passing by WR sensor 42. After passing by WR sensor 42, recording medium 2 passes between image formation section 10 and transfer unit 27. Recording medium 2 with a toner image transferred thereon by transfer unit 27 passes between fixing roller 31, which is a heating roller as a rotary body within fixing unit 30, and fixing belt 33 and is then detected by ejection sensor 44.

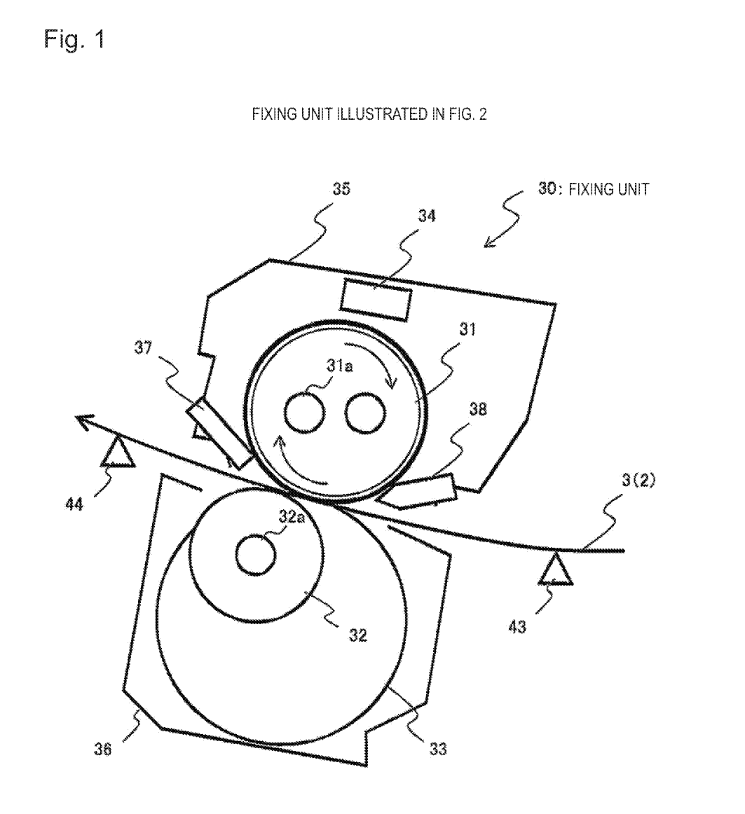

FIG. 1 is an enlarged diagram illustrating the belt-type fixing unit 30 illustrated in FIG. 2.

Belt-type fixing unit 30 includes fixing roller 31 as a heating roller, pressure roller 32 as a back-up roller, and fixing belt 33. Fixing belt 33 is provided between fixing roller 31 and pressure roller 32. Fixing belt 33 is provided so as to enclose pressure roller 32. Fixing roller 31 is controlled so as to rotate clockwise (in a first direction), as indicated by arrows in FIG. 1, during the fixing process and rotate counterclockwise (in a second direction) at the discharge of wrapped recording medium 2. Recording medium 2 with the toner image transferred thereto is nipped between fixing roller 31 and fixing belt 33. Within fixing roller 31, heat generator 31a, such as a halogen heater, is provided to heat the surface of fixing roller 31. Within pressure roller 32, heat generator 32a, such as a halogen heater, is provided to heat fixing belt 33.

Temperature sensor 34, such as a thermistor, is provided in or out of contact with fixing roller 31. Temperature sensor 34 detects and monitors the surface temperature of fixing roller 31 heated by heat generator 31a.

Fixing roller 31 and temperature sensor 34 are covered with cover 35. In a similar manner, pressure roller 32 and fixing belt 33 are covered with cover 36. Separator 37 is provided near fixing roller 31 on the downstream side thereof. Separator 37 separates recording medium 2 that has passed between fixing roller 31 and fixing belt 33 from fixing roller 31. Near fixing roller 31 on the upstream side thereof, discharge separator 38 as a discharge and separation member is provided at the symmetric position of separator 37. Discharge separator 38 is located at a predetermined distance from fixing roller 31 so as not to interfere with recording medium 2 conveyed downstream in fixing unit 30.

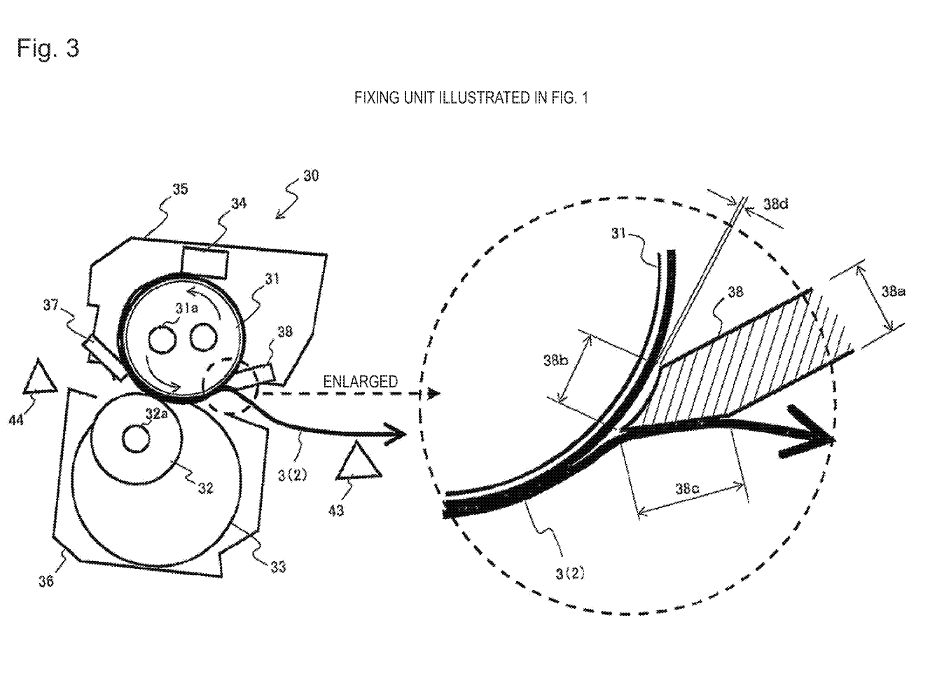

FIG. 3 is a diagram for explaining the configuration of discharge separator 38 in fixing unit 30 illustrated in FIG. 1.

Discharge separator 38 has a predetermined thickness 38a and has a wedge shape with a tip end tip of a V-shaped cross section. Gap 38d between surface 38b facing fixing roller 31 and the surface of fixing roller 31 is set to be small. Back surface 38c opposite to surface 38b has a function of separating recording medium 2 from fixing roller 31 when fixing roller 31 rotates counterclockwise as indicated by arrows in FIG. 3.

Discharge separator 38 is desirably positioned such that gap 38d between discharge separator 38 and fixing roller 31 is minimized because discharge separator 38 has a high effect on separating recording medium 2 when positioned as close to fixing roller 31 as possible. In light of the heat generation of fixing roller 31, discharge separator 38 needs to be resistant to heat. If discharge separator 38 is made of a rigid material, wrapped recording medium 2 remains at gap 38d between discharge separator 38 and fixing roller 31 and this could damage the surface of soft fixing roller 31. It is therefore desirable that discharge separator 38 is also made of a soft, flexible material.

When the tip portion of discharge separator 38 is made of a flexible member, discharge separator 38 itself needs to have a certain thickness 38a. The tip portion of discharge separator 38 is designed such that the surface 38b which faces fixing roller 31 has a profile along the circumferential surface of fixing roller 31 so as to make gap 38d as minimum as possible. This facilitates the detachion of recording medium 2 when wrapped around fixing roller 31. Moreover, since medium 2 detached from fixing roller 31 needs to be discharged to the outside of fixing unit 30 without resistance, the flexible member surface as back surface 38c of fixing roller 31 needs to be arranged at an appropriate position and angle for the discharge.

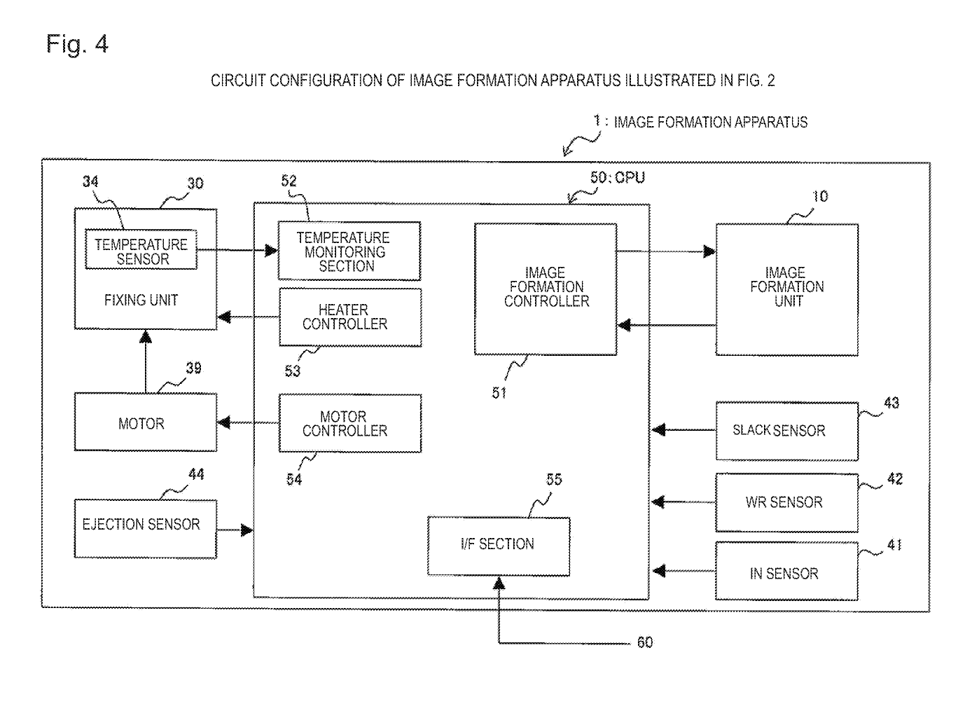

FIG. 4 is a block diagram illustrating a schematic circuit configuration of fixing unit 30 and its periphery in image formation apparatus 1 of FIG. 2.

Image formation apparatus 1 includes central processing unit (hereinafter, referred to as CPU) 50 to control the entire apparatus with programs. CPU 50 includes digital-to-analog conversion ports, general ports, and dedicated ports. These ports are connected to image formation section 10, fixing unit 30, motor 39, various sensors (IN sensor 41, WR sensor 42, slack sensor 43, and ejection sensor 44, for example), and the like.

CPU 50 includes: image formation controller 51 controlling image formation section 10; temperature monitoring section 52 monitoring the temperature of fixing unit 30; heater controller 53 controlling heat generators 31a and 32a of fixing unit 30; motor controller 54 controlling motor 39 to rotate the rollers of fixing unit 30; and interface section 55 (hereinafter referred to as the I/F section) exchanging signals with host device 60 such as an external PC. CPU 50 further includes a function to monitor the state of each sensor (IN sensor 41, WR sensor 42, slack sensor 43, and ejection sensor 44, for example). CPU 50 including such functions prints images on recording medium 2 by monitoring the states of sensors 41 to 44, driving motor 39, controlling heat generators 31a and 32a, and controlling image formation section 10 under program control.

Motor 39 and motor controller 54 constitute a rotation driver to rotate fixing roller 31, pressure roller 32, and fixing belt 33, which are rotary bodies. CPU 50, temperature sensor 34, slack sensor 43, and ejection sensor 44 constitute a wrap-around detection device to detect when recording medium 2 is wrapped around fixing roller 31.

### Normal Operation of Embodiment 1

In image formation apparatus 1 illustrated in FIG. 4, when I/F section 55 of CPU 50 receives a print instruction from host device 60, CPU 50 converts information of the print instruction to image data. Based on the obtained image data, CPU 50 controls the entire operation of image formation apparatus 1 with programs to start the printing operation.

In image formation apparatus 1 illustrated in FIG. 2, when the printing operation is started, paper feed roller pair 4, conveyance roller pair 5a, and the like operate, and recording medium 2 is conveyed downstream on conveyance path 3. Recording medium 2 is then detected by IN sensor 41. When conveyed recording medium 2 is detected by WR sensor 42, image formation section 10 operates under the control of image formation controller 51 of CPU 50 illustrated in FIG. 4.

In ID unit 20 (=20K to 20Y) for each color of image formation section 10, the surface of photoreceptive drum 21 is charged by charging roller 22. The surface of photoreceptive drum 21 is then exposed to a corresponding LED head 26 (=26K to 26Y) in accordance with image data, thus forming an electrostatic latent image. The formed electrostatic latent image is visualized on development roller 23 by toner supplied from supply roller 24, forming a toner image. The toner image on the photoreceptive drum 21 for each color is transferred by a corresponding transfer roller 27d (=27dK to 27dY) onto recording medium 2 on transfer belt 27c.

Recording medium 2 with the toner image transferred thereon is conveyed downstream on conveyance path 3 and is fed to fixing unit 30. When recording medium 2 slacks between the downstream side of image formation section 10 and transfer unit 27, and the upstream side of fixing unit 30, such a slack is detected by slack sensor 43. Motor 39 is then driven by motor controller 54 of CPU 50 illustrated in FIG. 4 to increase the speed of rotation of fixing roller 31 in fixing unit 30 and remove the slack of recording medium 2.

In FIGS. 1 and 2, recording medium 2 which has the toner images transferred thereon and is conveyed to fixing unit 30, is conveyed between fixing roller 31 and fixing belt 33, and the toner image on recording medium 2 is fixed by heat and pressure. Recording medium 2 with the toner images fixed thereon is detected by ejection sensor 44. When CPU 50 illustrated in FIG. 4 confirms that recording medium 2 with the toner images fixed thereon is discharged out of fixing unit 30, recording medium 2 is delivered to the outside of image formation apparatus 1 by conveyance roller pair 5b and delivery roller pair 6.

The above description shows a series of normal operations of image formation apparatus 1. Next, a description is given of operations in the case where recording medium 2 is wrapped around fixing roller 31.

### Operation in the Case Where Recording Medium is Wrapped Around Fixing Roller of Embodiment 1

The operations in this case are the same as the normal operations until recording medium 2 passes image formation section 10 and transfer unit 27. As illustrated in FIGS. 1 and 2, recording medium 2 which has reached fixing unit 30 is conveyed between fixing roller 31 and fixing belt 33, and the toner image on recording medium 2 is fixed by pressure and heat.

In the normal operations, recording medium 2 discharged from fixing roller 31 is conveyed downward by separator 37. In abnormal operations, recording medium 2 goes into a gap between separator 37 and fixing roller 31 to be wrapped around fixing roller 31 along the arrowed path in FIG. 3 instead of being conveyed toward ejection sensor 44. In this case, ejection sensor 44 does not detect recording medium 2, and the occurrence of an ejection jam error is determined in the control.

Next, a description is given with reference to FIG. 4 of the operations in the case of an ejection jam error.

When receiving information from host device 60 through I/F section 55, CPU 50 converts the received information to image data. The surface temperature of fixing roller 31 in fixing unit 30, which is being detected by temperature sensor 34, is monitored by temperature monitoring section 52 of CPU 50. Simultaneously, motor 39 is driven with motor controller 54 of CPU 50 to rotate fixing roller 31 and other rollers in fixing unit 30. The control of the above operation continues until the surface temperature of fixing roller 31 in fixing unit 30 reaches a proper temperature. The operation hereinabove is a stand-by operation before printing.

When the surface temperature of fixing roller 31 reaches the proper temperature, CPU 50 waits for recording medium 2 to be conveyed downstream by the rotation of fixing roller 31. When recording medium 2 is conveyed downstream, recording medium 2 conveyed next is detected by IN sensor 41 and is then detected by WR sensor 42.

When WR sensor 42 detects recording medium 2, image data is transmitted from image formation controller 51 of CPU 50 to image formation section 10, which then forms toner images. The toner images are transferred onto recording medium 2 by transfer unit 27. Recording medium 2 with the toner images transferred thereon is further conveyed downstream, and the toner images on recording medium 2 are fixed by fixing unit 30 which is heated in advance in the stand-by operation. Recording medium 2 with the toner images fixed thereon is then discharged downward and is detected by ejection sensor 44.

When slack sensor 43 detects recording medium 2 between image formation section 10 (transfer unit 27) and fixing unit 30, CPU 50 recognizes that recording medium 2 has a slack between image formation section 10 (transfer unit 27) and fixing unit 30, and motor controller 54 of CPU 50 adjusts the rotational speed of motor 39 to control the rotation until the result of detection by slack sensor 43 changes.

When ejection sensor 44 does not detect recording medium 2 after the toner images are fixed on recording medium 2 in fixing unit 30, CPU 50 determines that recording medium 2 is jammed between fixing unit 30 and ejection sensor 44. In this case, CPU 50 stops heater controller 53 and motor controller 54 and enters a jam error status.

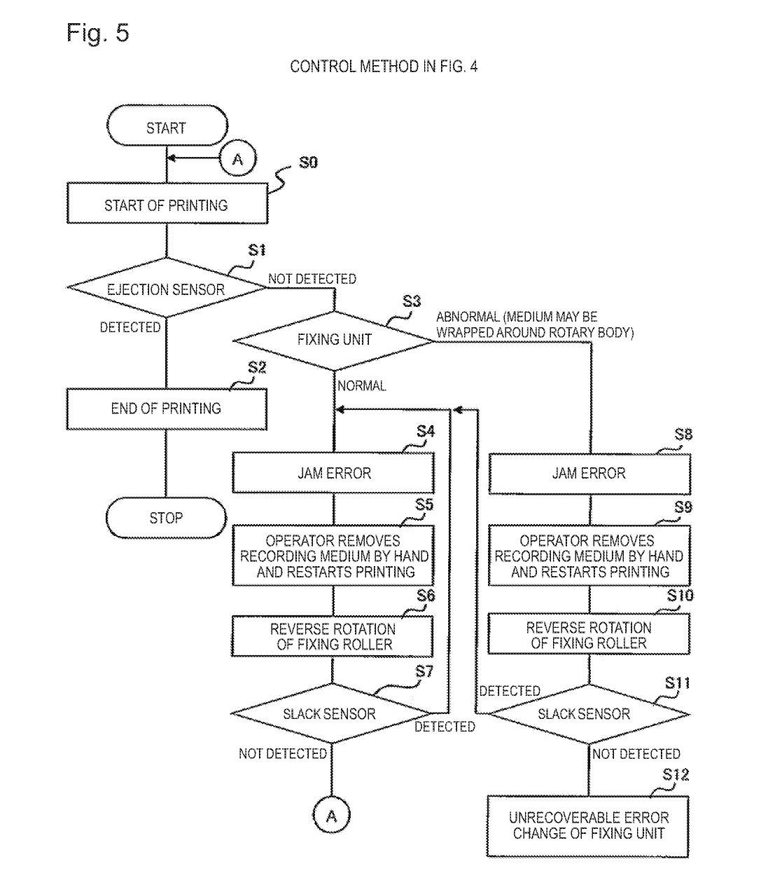

Next, a description is given of a control method in the case of a jam error with reference to FIG. 5.

FIG. 5 is a flowchart illustrating a control method of CPU 50 in the case of a jam error in image formation apparatus 1 of FIG. 4.

This flowchart includes processes in steps S0 to S12. In steps S0 and S2, an image formation and transfer process and a fixing process are conducted. In steps S1, S3, S4, S7, S8, and S11, a wrap-around detection process is conducted. In steps S6 and S10, a medium separation and discharge process including a rotation driving process and a separation and discharge process is conducted.

First in step S0, the image formation/transfer process and fixing process as the printing operation of image formation apparatus 1 are started, and CPU 50 goes to step S1. In step S1, CPU 50 monitors the result of the detection by ejection sensor 44. When ejection sensor 44 detects recording medium 2, CPU 50 goes to step S2. When ejection sensor 44 does not detect recording medium 2, CPU 50 goes to step S3. In step S2, CPU50 determines that the printing operation is normal and terminates the control for printing to stop the printing operation.

In step S3, temperature monitoring section 52 of CPU 50 monitors the result of the detection by temperature sensor 34, which detects the surface temperature of fixing roller 31. When the detection result is normal, CPU 50 goes to step S4. When the detection result is abnormal, CPU 50 suspects that recording medium 2 is wrapped around fixing roller 31 and goes to step S8.

In step S4, CPU 50 determines that there is a jam error and stops the printing operation and goes to step S5. In step S5, CPU 50 comes into the stand-by state where image formation apparatus 1 does not restart until the operator removes recording medium 2 by hand. CPU 50 then displays on a display unit of image formation apparatus 1 that image formation apparatus 1 is in the stand-by state. When the operator notices the jam error, the operator opens an outer cover of image formation apparatus 1 and looks for recording medium 2 in image formation apparatus 1. However, the operator cannot see recording medium 2 in fixing unit 30 because the fixing unit 30 is covered with covers 35 and 36. When the operator then closes the outer cover and operates the operation unit of image formation apparatus 1 for restart, CPU 50 goes to step S6.

In step S6, based on the restart operation by the operator, motor controller 54 of CPU 50 drives motor 39 to rotate fixing roller 31 in reverse in the upstream direction. When fixing roller 31 rotates in reverse, recording medium 2 wrapped around fixing roller 31 is discharged out of fixing unit 30 by discharge separator 38. Next in step S7, CPU 50 monitors the result of the detection by slack sensor 43. When slack sensor 43 detects recording medium 2, CPU 50 returns to step S4 because the detection of recording medium 2 means that recording medium 2 which should not have existed is detected.

Back to step S4, CPU 50 again determines that image formation unit 1 is in a jam error and displays the jam error result on the display unit of image formation apparatus 1. The operator realizes the jam error again and rechecks the inside of image formation apparatus 1 for recording medium 2. In this process, the operator sees recording medium 2 located between fixing unit 30 and image formation section 10 (transfer unit 27). In step S5, the operator sees and removes recording medium 2 discharged out of fixing unit 30 by the reverse rotation and then performs the restart operation through the operation unit of image formation apparatus 1. CPU 50 then goes to step S6. In step S6, motor controller 54 of CPU 50 drives motor 39 again to rotate fixing roller 31 in reverse for a certain length of time based on the restart operation by the operator. CPU 50 then goes to step S7. In step S7, CPU 50 monitors the result of the detection by slack sensor 43. When recording medium 2 is not detected, CPU 50 returns to step S0 via connectors A and conducts printing again.

When CPU 50 suspects that recording medium 2 is wrapped around fixing roller 31 based on the abnormal result of detection by temperature sensor 34 in step S3, CPU 50 goes to step S8, sets image formation apparatus 1 to a jam error, and goes to step S9. In step S9, CPU 50 comes into the stand-by state where image formation apparatus 1 does not restart until the operator removes recording medium 2 by hand, and displays on the display unit of image formation apparatus 1 that image formation apparatus 1 is in the stand-by state. When the operator notices the jam error, the operator opens the outer cover of image formation apparatus 1 and checks the inside of image formation apparatus 1 for recording medium 2. However, the operator cannot see recording medium 2 in fixing unit 30 because wrapped recording medium 2 is present inside fixing unit 30. When the operator then closes the outer cover and operates the operation unit of image formation apparatus 1 for a restart, CPU 50 goes to step S10.

In step S10, based on the restart operation by the operator, motor controller 54 of CPU 50 drives motor 39 to rotate fixing roller 31 in reverse in the upstream direction. When fixing roller 31 rotates in reverse, recording medium 2 wrapped around fixing roller 31 is discharged out of fixing unit 30 by discharge separator 38. Next in step S11, CPU 50 monitors the result of the detection by slack sensor 43. When slack sensor 43 detects recording medium 2, CPU 50 returns to step S4 because detection of slack sensor 43 means that recording medium 2 which should not have existed is detected.

Back in step S4, CPU 50 again determines that image formation apparatus 1 is in a jam error and displays the jam error result on the display unit of image formation apparatus 1. The operator realizes the jam error again and rechecks the inside of image formation apparatus 1 for recording medium 2. In this process, the operator sees recording medium 2 located between fixing unit 30 and image formation section 10 (transfer unit 27). In step S5, the operator sees and removes recording medium 2 discharged out of fixing unit 30 by reverse rotation and then performs the restart operation through the operation unit of image formation apparatus 1. CPU 50 then goes to step S6. In step S6, motor controller 54 of CPU 50 drives motor 39 again to rotate fixing roller 31 in reverse for a certain length of time based on the restart operation by the operator. CPU 50 then goes to step S7. In step S7, CPU 50 monitors the result of the detection by slack sensor 43. When recording medium 2 is not detected, CPU 50 returns to step S0 via connectors A and conducts printing again.

When slack sensor 43 does not detect recording medium 2 in step S11, CPU 50 goes to step S12. In step S12, CPU 50 determines that image formation apparatus 1 is in an unrecoverable error because temperature sensor 34 already detects an abnormal value in step S3. CPU 50 displays the occurrence of the unrecoverable error on the display unit of image formation apparatus 1 and prompts the operator to change fixing unit 30, for example.

### Effects of Embodiment 1

According to image formation apparatus 1 of Embodiment 1, the following effects A to C are expected.

(A) It is possible to precisely detect wrapped recording medium 2 remaining in fixing unit 30.

(B) Since fixing roller 31 is covered with cover 35, recording medium 2 wrapped around fixing roller 31 cannot be seen directly sometimes, and the operator therefore could overlook jammed recording medium 2 when trying to remove jammed recording medium 2. According to Embodiment 1, however, the likelihood of such an occurrences can be eliminated. The reverse rotation of fixing roller 31 enables recording medium 2 wrapped around fixing roller 31 to be removed and discharged out of fixing unit 30 with discharge separator 38.

(C) Recording medium 2 removed in (B) above can be detected by existing slack sensor 43.

### (Modifications)

The invention is not limited to Embodiment 1 described above, and various usages and modifications thereof can be implemented. Such usages and modifications include the following (a) to (g), for example.

(a) In Embodiment 1, the description is given of the case where recording medium 2 is wrapped around fixing roller 31. However, the invention has the same effects as those of Embodiment 1 in the case where recording medium 2 is wrapped around fixing belt 33.

(b) The description in Embodiment 1 is given of the case where recording medium 2 is wrapped around fixing roller 31 of belt-type fixing unit 30, but the invention is not limited thereto. Embodiment 1 is applicable to a roller-type fixing unit in which fixing roller 31 and pressure roller 3 as rotary bodies are directly in contact with each other without using fixing belt 33, and recording medium 2 is nipped between fixing roller 31 and pressure roller 32 for fixing.

(c) Instead of discharge separator 38 in FIG. 1, an end portion of cover 35, which is provided besides fixing roller 31, may be used as a discharge separator. This can provide the same effects as those of Embodiment 1.

(d) Recording medium 2, discharged by the reverse rotation of fixing unit 30, is detected by slack sensor 43 but may also be detected by any type of sensor. Slack sensor 43 can be easily substituted for any sensor that is capable of detecting recording medium 2.

(e) In the control of Embodiment 1, the reverse rotation is performed at the time of restart. However, fixing roller 31 may rotate forward on purpose before rotating in reverse. Recording medium 2 is thereby completely wrapped around fixing roller 31 and can easily be discharged with discharge separator 38 by the reverse rotation. This can provide the same effects as those of Embodiment 1.

(f) In the description of Embodiment 1, fixing roller 31 is rotated in reverse for a predetermined length of time. However, it is unnecessary to define the length of time for the reverse rotation if an amount of rotation corresponding to the distance which the sensor can detect is controlled.

(g) In the description of Embodiment 1, image formation apparatus 1 is an electrophotographic color printer by way of example. The invention is also applicable to monochrome printers, facsimiles, copiers, multifunction printers, and the like.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An image formation apparatus, comprising:
an image formation device configured to form a developer image based on image data;
a transfer device configured to transfer the developer image formed by the image formation device onto a recording medium;
a fixing unit including a rotary body and configured to, when the recording medium with the developer image transferred thereon is conveyed from an upstream side in a conveyance path, fix the developer image by rotating the rotary body in a first direction to move the recording medium to a downstream side in the conveyance path while heating and pressing the recording medium, and
a wrap-around detection device configured to detect if the recording medium with the developer image transferred thereto is wrapped around the rotary body, wherein
the wrap-around detection device detects if the recording medium is wrapped around the rotary body, based on a temperature detection result of detecting temperature of the rotary body and medium detection results of detecting the recording medium on the upstream and downstream sides of the rotary body.

2. The image formation apparatus according to clam 1, further comprising a medium separation and discharge device configured to, when the wrap-around detection device detects that the recording medium is wrapped around the rotary body, rotate the rotary body in a second direction opposite to the first direction, separate the recording medium wrapped around the rotary body from the rotary body, and discharge the recording medium to the upstream side.

3. The image formation apparatus according to claim 2, wherein the medium separation and discharge device includes:
a rotation driver configured to rotate the rotary body in the second direction when the wrap-around detection device detects that the recording medium is wrapped around the rotary body; and
a discharge separation member provided on the upstream side of the rotary body and configured, when the rotary body rotates in the second direction, to separate the recording medium wrapped around the rotary body from the rotary body and discharge the recording medium to the upstream side.

4. The image formation apparatus according to claim 1, wherein the rotary body is covered with a cover.

5. The image formation apparatus according to claim 1, wherein the wrap-around detection device includes:
a temperature sensor provided in or out of contact with the rotary body, and configured to detect temperature of the rotary body and output the temperature detection result;
a first medium sensor provided on the upstream side of the rotary body, and configured to detect the recording medium with the developer image transferred thereon, and output a first medium detection result indicating the medium is detected on the upstream side of the rotary body;
a second medium sensor provided on the downstream side of the rotary body, and configured to detect the recording medium with the developer image fixed thereon, and output a second medium detection result indicating the medium is detected on the downstream side of the rotary body, and
the wrap-around detection device detects that the recording medium is wrapped around the rotary body based on the temperature detection result and the first or second medium detection results.

6. The image formation apparatus according to claim 1, wherein the rotary body includes:
a fixing roller in which a heat generator is enclosed; and
a fixing belt laid between the fixing roller and a pressure roller configured to press the recording medium with the developer image transferred thereon against the fixing roller, the pressure roller being enclosed inside the fixing belt.

7. The image formation apparatus according to claim 1, wherein the rotary body includes:
a fixing roller in which a heat generator is enclosed; and
a pressure roller configured to press the recording medium with the developer image transferred thereon against the fixing roller.

8. A method of controlling an image formation apparatus, comprising:
an image formation and transfer process of forming a developer image based on image data and transferring the developer image onto a recording medium;
a fixing process of, when the recording medium with the developer image transferred thereon is fed from an upstream side on a conveyance path, fixing the developer image on the recording medium by using a rotary body rotating in a first direction to move the recording medium with the developer image transferred thereon to a downstream side on the conveyance path while heating and pressing the recording medium; and
a wrap-around detection process to detect when the recording medium is wrapped around the rotary body during the fixing process, wherein
the wrap-around detection process includes detecting the recording medium is wrapped around the rotary body based on a temperature detection result of detecting temperature of the rotary body and medium detection results of detecting the recording medium on the upstream and downstream sides of the rotary body.

9. The method of controlling an image formation apparatus according to claim 8, wherein the wrap-around detection process includes
obtaining the temperature detection result by detecting the temperature of the rotary body with a temperature sensor which is provided in or out of contact with the rotary body,
obtaining a first one of the medium detection results by detecting the recording medium on the upstream side of the rotary body with a first medium sensor provided on the upstream side of the rotary body, and
obtaining a second one of the medium detection results by detecting the recording medium on the downstream side of the rotary body with a second medium sensor provided on the downstream side of the rotary body.

10. The method of controlling an image formation apparatus according to claim 8, further comprising a medium separation and discharge process of, when it is detected that the recording medium is wrapped around the rotary body, rotating the rotary body in a second direction opposite to the first direction, separating the recording medium from the rotary body, and discharging the recording medium to the upstream side.

11. The method of controlling an image formation apparatus according to claim 10, wherein the medium separation and discharge process includes:
a rotation driving process of rotating the rotary body in the second direction when it is detected that the recording medium is wrapped around the rotary body; and
a separation and discharge process of causing a discharge separation member provided on the upstream side of the rotary body to separate the recording medium adhering to the rotary body from the rotary body and discharge the recording medium to the upstream side while the rotary body is rotating in the second direction.

12. A fixing unit, comprising:
a rotary body configured to, when a recording medium with a developer image transferred thereto is fed from an upstream side on a conveyance path, fix the developer image onto the recording medium by rotating in a first direction to move the recording medium to a downstream side on the conveyance path while heating and pressing the recording medium; and
a discharge separation member configured to separate the recording medium wrapped around the rotary body from the rotary body and discharge the recording medium, wherein
the discharge separation member is provided on the upstream side of the rotary body and is configured to separate the recording medium wrapped around the rotary body from the rotary body and discharge the recording medium to the upstream side while the rotary body is rotating in a second direction opposite to the first direction in response to a detection that the recording medium is wrapped around the rotary body.

13. The fixing unit according to claim 12, wherein the discharge separation member includes a discharge separator provided near the rotary body on the upstream side, a cross-section of the discharge separator being in a wedge shape.

14. The fixing unit according to claim 12, wherein the discharge separation member includes a discharge separation body formed near an upstream end of a cover that covers the rotary body, a cross section of the discharge separation body being in a wedge shape.
